(19) United States
(12) Patent Application Publication
(10) Pub. No.: US 2026/0368642 A1
(43) Pub. Date: Nov. 19, 2026

(54) LANGUAGE-DRIVEN EDITING OF IMAGE SCENES WITH MACHINE LEARNING

(71) Applicant: NEC Laboratories America, Inc., Princeton, NJ (US)

(72) Inventors: Ziyu Jiang, Sunnyvale, CA (US); Abhishek Aich, San Jose, CA (US); Zaid Tasneem, San Jose, CA (US); Mauricio Soroco, San Jose, CA (US)

(21) Appl. No.: 19/674,437

(22) Filed: May 12, 2026

Related U.S. Application Data
(60) Provisional application No. 63/805,350, filed on May 14, 2025.
(60) Provisional application No. 63/820,777, filed on Jun. 10, 2025.
(60) Provisional application No. 63/882,530, filed on Sep. 16, 2025.
(60) Provisional application No. 63/886,321, filed on Sep. 23, 2025.
(60) Provisional application No. 63/886,354, filed on Sep. 23, 2025.

(51) Int. Cl. G06N 20/00; G06T 11/60

(52) U.S. Cl. CPC G06N 20/00; G06T 11/60

(57) ABSTRACT

Systems and methods for language-driven editing of image scenes with machine learning. A scene context of a source image that describes detected entities and conditions of the source image can be determined with a vision-language model (VLM). Pixel-wise information of the detected entities relevant to the scene context can be masked based on an editing prompt determined from user queries and the source image to obtain editing masks. Text descriptions and cropped images of the detected entities can be encoded with the VLM. Transformations on the source images that preserve unedited content and align with the user query based on a context feedback loss based on the text descriptions and cropped images can be performed to obtain an augmented dataset including language-driven edited images. A trained machine learning model can be retrained with the augmented dataset for performing downstream tasks.

### RELATED APPLICATION INFORMATION

This application claims priority to U.S. Provisional App. No. 63/805,350, filed on May 14, 2025, U.S. Provisional App. No. 63/820,777, filed on Jun. 10, 2025, U.S. Provisional App. No. 63/882,530, filed on Sep. 16, 2025, U.S. Provisional App. No. 63/886,321, filed on Sep. 23, 2025, and U.S. Provisional App. No. 63/886,354, filed on Sep. 23, 2025, incorporated herein by reference in their entirety.

### BACKGROUND

### Technical Field

The present invention relates to optimizing artificial intelligence (AI) model processing and more particularly to language-driven editing of image scenes with machine learning.

### Description of the Related Art

Artificial Intelligence (AI) models can be utilized to process various modalities such as texts, images, and videos. AI models can be trained to do specific domain-level processing such as image generation, text generation, and video generation for specific domains such as autonomous driving, healthcare data summarization, entity description, etc.

### SUMMARY

According to an aspect of the present invention, a method is provided including, determining a scene context of a source image that describes detected entities and conditions of the source image with a vision-language model (VLM), masking pixel-wise information of the detected entities relevant to the scene context based on an editing prompt determined from user queries and the source image to obtain editing masks, encoding text descriptions and cropped images of the detected entities with the VLM, performing transformations on the source images that preserve unedited content and align with the user query based on a context feedback loss based on the text descriptions and cropped images to obtain an augmented dataset including language-driven edited images, and retraining a trained machine learning model with the augmented dataset to obtain a retrained machine learning model for performing downstream tasks.

According to another aspect of the present invention, a system is provided, including, a memory device, one or more processor devices operatively coupled with the memory device to perform operations including, determining a scene context of a source image that describes detected entities and conditions of the source image with a vision-language model (VLM), masking pixel-wise information of the detected entities relevant to the scene context based on an editing prompt determined from user queries and the source image to obtain editing masks, encoding text descriptions and cropped images of the detected entities with the VLM, performing transformations on the source images that preserve unedited content and align with the user query based on a context feedback loss based on the text descriptions and cropped images to obtain an augmented dataset including language-driven edited images, and retraining a trained machine learning model with the augmented dataset to obtain a retrained machine learning model for performing downstream tasks.

According to yet another aspect of the present invention, a non-transitory computer program product is provided including a computer-readable storage medium including a program code, wherein the program code when executed on a computer causes the computer to perform operations including, determining a scene context of a source image that describes detected entities and conditions of the source image with a vision-language model (VLM), masking pixel-wise information of the detected entities relevant to the scene context based on an editing prompt determined from user queries and the source image to obtain editing masks, encoding text descriptions and cropped images of the detected entities with the VLM, performing transformations on the source images that preserve unedited content and align with the user query based on a context feedback loss based on the text descriptions and cropped images to obtain an augmented dataset including language-driven edited images, and retraining a trained machine learning model with the augmented dataset to obtain a retrained machine learning model for performing downstream tasks

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for language-driven editing of image scenes with machine learning, in accordance with an embodiment of the present invention;

FIG. 2 is a block diagram that shows a computer system for language-driven editing of image scenes with machine learning, in accordance with an embodiment of the present invention; and

FIG. 3 is a block diagram that shows components of a computer system for language-driven editing of image scenes with machine learning, in accordance with an embodiment of the present invention;

FIG. 4 is a block diagram that shows components of a computer system that computes a cycle consistency loss for language-driven editing of image scenes with machine learning, in accordance with an embodiment of the present invention;

FIG. 5 is a block diagram that shows components of a computer system that computes an identity consistency loss for language-driven editing of image scenes with machine learning, in accordance with an embodiment of the present invention;

FIG. 6 is a block diagram that shows components of a computer system that computes a context feedback loss for language-driven editing of image scenes with machine learning, in accordance with an embodiment of the present invention;

FIG. 7 is a block diagram that shows image processing for language-driven editing of image scenes with machine learning, in accordance with an embodiment of the present invention;

FIG. 8 is a flow diagram that shows a high-level overview of language-driven editing of image scenes with machine learning, in accordance with an embodiment of the present invention; and

FIG. 9 is a block diagram that shows a practical application of language-driven editing of image scenes with machine learning, in accordance with an embodiment of the present invention.

### DETAILED DESCRIPTION OF PREFERRED EMBODIMENTS

In accordance with embodiments of the present invention, systems and methods are provided for language-driven editing of image scenes with machine learning.

In the present embodiments, a scene context of a source image that describes detected entities and conditions of the source image can be determined with a vision-language model (VLM). Pixel-wise information of the detected entities relevant to the scene context can be masked based on an editing prompt determined from user queries and the source image to obtain editing masks. Text descriptions and cropped images of the detected entities can be encoded with the VLM. Transformations on the source images that preserve unedited content and align with the user query based on a context feedback loss based on the text descriptions and cropped images can be performed to obtain an augmented dataset including language-driven edited images. A trained machine learning model can be retrained with the augmented dataset for performing downstream tasks.

Ensuring safety remains the foremost challenge in bringing autonomous driving technology into everyday use. One widely adopted method for evaluating these systems is to test them on real-world data manually collected from their intended Operational Design Domain (ODD). However, the dynamic nature of ODD environments-shaped by variables such as lighting, weather, traffic flow, and road conditions-poses a significant limitation. These constantly shifting factors make it challenging, if not infeasible, to comprehensively collect real-world data and test the algorithm across the full spectrum of real-world scenarios. Particularly challenging are “long-tail” scenarios-rare but critical driving situations that occur infrequently but often represent edge cases with high safety implications.

Generative models, with their efficient and scalable capabilities for scene synthesis and modification, have emerged as a promising solution to generate diverse driving scene environments. In particular, instruction-guided image-editing models stand out as a potential solution for producing various variations of autonomous-driving scenes: they afford fine-grained and flexible language-based control while leveraging the realism of large-scale pretrained sources Consequently, these models can potentially offer rapid, scalable, and cost-effective approaches to augmenting datasets to cover corner cases.

Despite the promise, two properties critical to autonomous driving scenes are not explicitly enforced when applying the aforementioned generative instruction-guided editing: content preservation and instruction alignment. Content preservation focuses on retaining the unedited elements of a driving scene during transformation. Editing models may unintentionally modify or remove essential content-such as traffic signs, lane markings, or surrounding vehicles-potentially leading to incorrect visual signals for downstream perception and planning systems by altering safety critical elements. Meanwhile, instruction alignment refers to the accurate execution of detailed, multi-attribute natural-language instructions. Strong instruction alignment not only supports human-in-the-loop workflows but also enables systematic exploration of the combinatorial space of scene factors-weather, illumination, traffic composition, viewpoint, and beyond-ensuring that each syntactic variation of an instruction is faithfully realized in the output, thereby achieving a degree of diversity and granularity unattainable through unguided random sampling.

The primary bottleneck in addressing these questions lies in the lack of paired datasets containing fine-grained visual or textual prompts for instruction-guided driving scene editing.

To resolve these issues, the present embodiments generate an augmented dataset that includes both synthetic and real-world driving scenarios. The synthetic part captures both global changes and precise object-level edits by simulating pairs of driving videos from the perspective of an ego vehicle, with only a single attribute altered between each pair. This supports rich editing types and fine-grained instructions. The real-world part captures a large amount of environmental variations-such as season, lighting, and weather-alongside multiple concurrent object-level differences among road users.

The present embodiments support detailed control of the generation of diffusion models with precise editing instructions and pixel-level masks using large language models integrated with a multi-modal vision pipeline.

While many image generation works focus on object centric modifications which are centered around a single object, traffic images contain dense information in the form of multiple instances such as vehicles, pedestrians and buildings. Describing localized information for dense scenes is challenging with natural language prompts alone. To this end, the present embodiments introduce pixel level masks with localized semantics described in natural language and encoded in each pixel.

Across different state-of-the-art editing models, comprehensive experiments for the present embodiments demonstrate that after training (or fine-tuning) on the generated augmented dataset, both content preservation and instruction alignment are largely improved for machine learning models. Additionally, the augmented dataset increases lane detection performance on an out of distribution driving dataset, highlighting the potential of instruction-guided editing for safety-critical applications. Furthermore, to scale driving scene editing to various traffic conditions, the present embodiments introduce unsupervised training methods that encourage content preservation via cycle and identity objectives, and also instruction alignment via similarity objectives and adversarial training.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

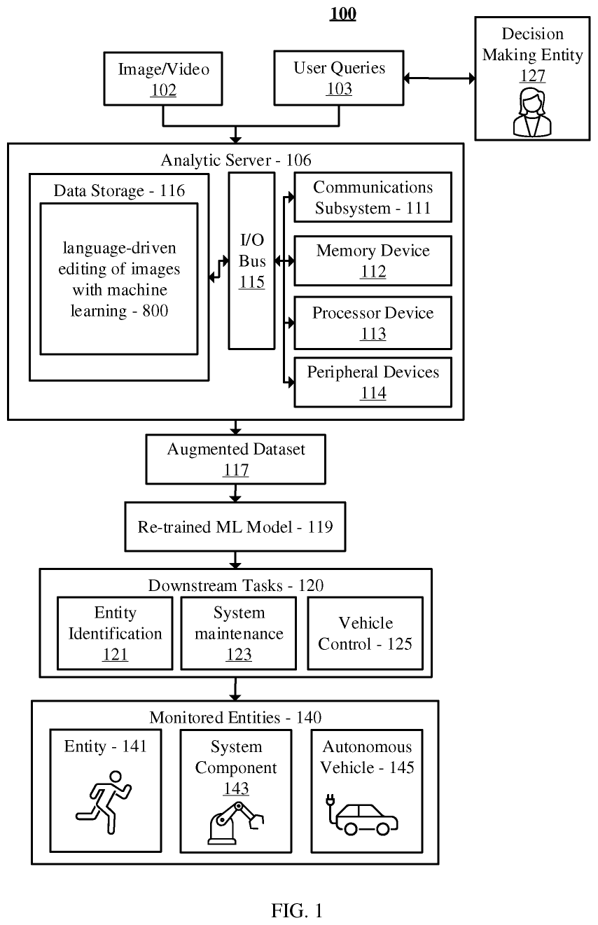

Referring now in detail to the figures in which like numerals represent the same or similar elements and initially to FIG. 1, a block diagram shows a system for language-driven editing of image scenes with machine learning, in accordance with an embodiment of the present invention.

In an embodiment using a system 100, monitored entities 140 can include entity 141, system component 143, and autonomous vehicle 145. The monitored entities 140 can generate an input dataset that includes image/video 102. The source image/video 102 can be transmitted to an analytic server 106 that can implement language-driven editing of image scenes with machine learning 500. The analytic server 106 can obtain an augmented dataset 117 that includes fine-grained details that were updated or inserted based on user queries 103 that are provided by a decision-making entity that can be utilized to train a machine learning model and obtain a retrained machine learning model 119. The retrained machine learning model 119 can be utilized to perform downstream tasks 120.

System 100 can be utilized to perform downstream tasks 120 based on the input dataset 101 and user queries 128 from a decision-making entity 127. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the input dataset 101 (e.g., location images, scene images, entity images such as parts of the entity, etc.) related to the entity 141 can be processed by the analysis server 106 to answer user queries 128. The user queries 128 can be relevant to the entity 141 such as their attributes (e.g., position, direction of movement, color of clothing, etc.), relationship with other entities within a scene (e.g., proximity, behavior, etc.), relationship with the environment, etc. The retrained machine learning model 119 can predict future attributes, and relationships of the entity 141.

Based on the predictions of the retrained machine learning model 119, a corrective action can be generated. The corrective action can include notifying the decision making entity 127 of the predictions about the entity 141 based on their input dataset 101, generating resolutions to an issue caused by the entity (e.g., the entity 141 as a disabled vehicle in a traffic scene and the resolution is the deployment of a repair technician, etc.) of the input dataset 101 to help with the decision making process of the decision making entity 127, etc.

In system maintenance 123, input dataset 101 (e.g., system logs, test cases, hardware status images, etc.) related to the system component 143 can be processed to answer user queries 128. The user queries 128 can be relevant to how to properly maintain the system component 143 based on the input dataset 101. A corrective action can be generated by the analytic server 106 which can include the answer to the user queries 128 (e.g., determine causes of bandwidth issues, etc.) to maintain the system component 143. Based on the corrective action (e.g., adding bandwidth, blocking packets from an identified internet protocol (IP) address to resolve malicious attacks, restarting hardware, etc.) the network system can be autonomously maintained.

In vehicle control 125, input dataset 101 (e.g., vehicle part status, traffic scene image, etc.) related to the autonomous vehicle 145 can be processed to answer user queries 128. The user queries 128 can be relevant to how to control the autonomous vehicle 145 given its environment based on the input dataset 101. A corrective action can be generated by the analytic server 106 which can include the answer to the user queries 128 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generating test data that can be used to fine-tune/train the retrained machine learning model 119.

Other downstream tasks and practical applications are contemplated.

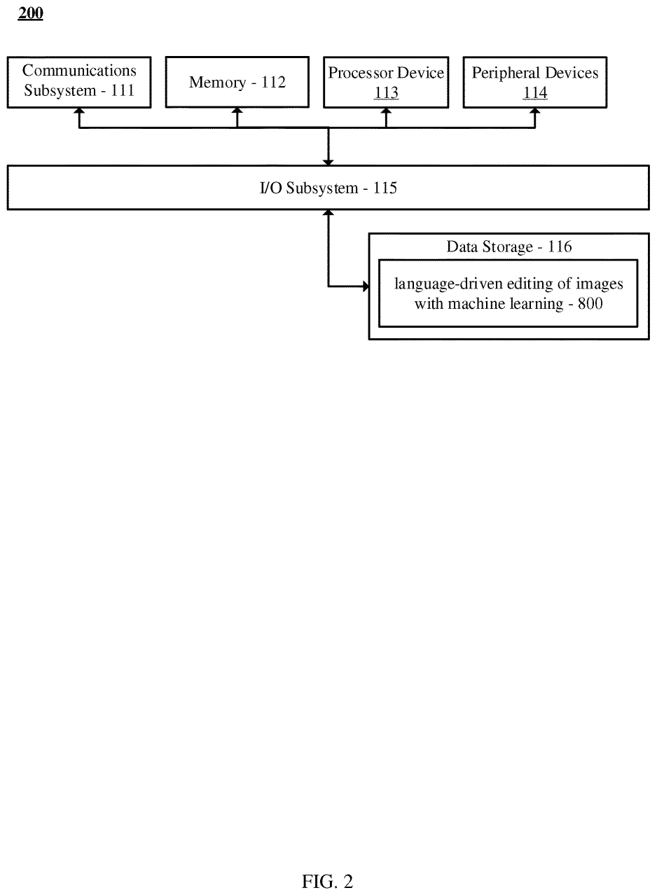

The analytic server 106 can include a processor device 113, a data storage device 116, a memory 112, a communications subsystem 111, peripheral devices 114, and an input/output (I/O) bus 115. The analytic server 106 is an implementation of a computer system. Other implementations are contemplated. The computer system is shown in more detail in FIG. 2.

Referring now to FIG. 2, a block diagram shows a computer system for language-driven editing of image scenes with machine learning, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, extracted control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single extracted circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for language-driven editing of image scenes with machine learning 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in the computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

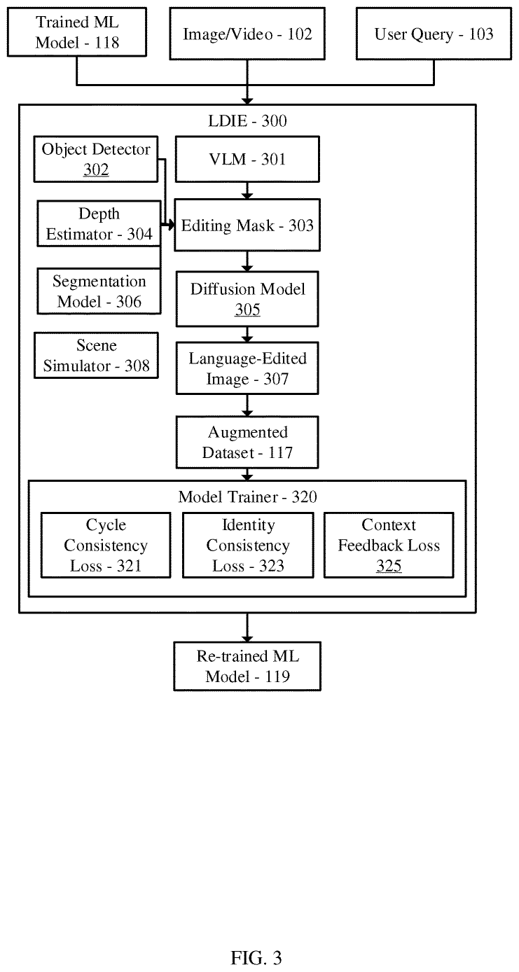

Referring now to FIG. 3, a block diagram shows components of a computer system for language-driven editing of image scenes with machine learning, in accordance with an embodiment of the present invention.

In an embodiment, source image/video 102 and user query 103 can be processed by a language-driven image editor (LDIE) 300 to generate an augmented dataset 117 to train a trained ML Model 118 with a model trainer 320 and obtain a retrained ML model 119. The user query 103 can include text instructions to edit a scene shown by the image/video 102.

The LDIE 300 can utilize a visual language model 301, object detector 302, depth estimator 304, segmentation model 306, scene simulator 308 to generate an editing mask 303 from the source image/video 102 and the user query 103. The LDIE 300 can process the source image/video 102, user query 103 and editing mask 303 to generate a language-edited image 307. The augmented dataset 117 can include the language-edited image 307.

The model trainer 320 can utilize cycle consistency loss 321, identity consistency loss 323, and context feedback loss 325 to train the trained ML model 118 and obtain a retrained ML model 119. The cycle consistency loss 321 determines how consistent the un-edited entities of the language-edited image 307 are with the source image/video 102. The identity consistency loss 323 determines how similar the edited entities of the language-edited image 307 are to ground truth images of the edited entities. The context feedback loss 325 determines how a visual language model would describe the language-edited image and its similarity to a context of the user query 103.

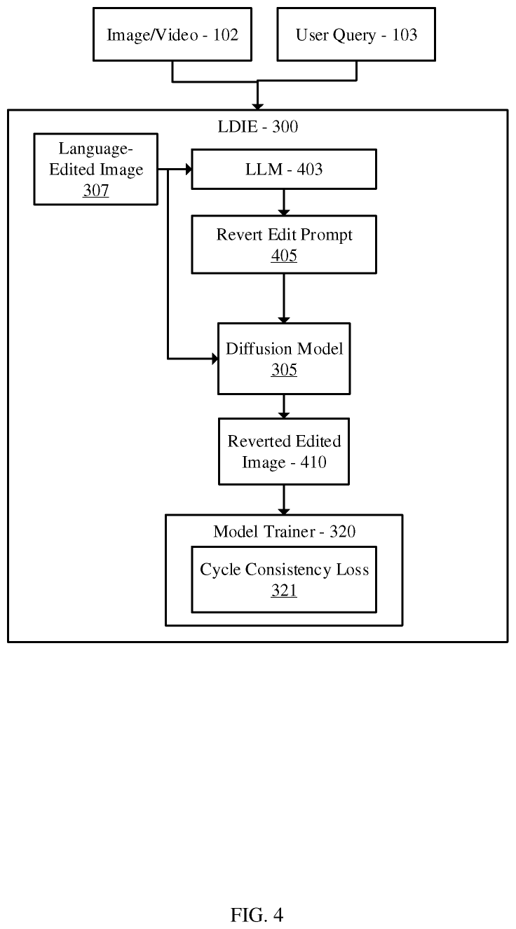

Referring now to FIG. 4, a block diagram shows components of a computer system that computes a cycle consistency loss for language-driven editing of image scenes with machine learning, in accordance with an embodiment of the present invention.

In an embodiment, the LDIE 300 can process source image/video 102 and user query 103 to determine the cycle consistency loss 321 for training. The language-edited image 307 can be processed by a large language model 403 to generate a revert edit prompt 405. The revert edit prompt 405 and the language-edited image 307 can be utilized by the diffusion model 305 to generate a reverted edited image 410. The reverted edited image 410 and the source image/video 102 can be processed to determine the cycle consistency loss 321.

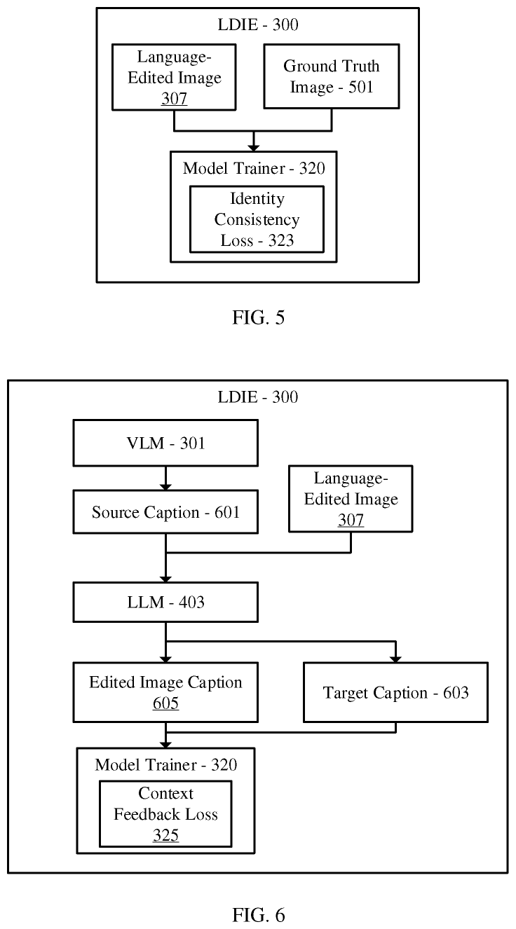

Referring now to FIG. 5, a block diagram shows components of a computer system that computes an identity consistency loss for language-driven editing of image scenes with machine learning, in accordance with an embodiment of the present invention.

In an embodiment, the LDIE 300 can process source image/video 102 and user query 103 to determine the identity consistency loss 323 for training. The language-edited image 307 generated by the LDIE 300 and a ground truth image 501 obtained from datasets can be processed by the model trainer 320 to determine the identity consistency loss 323.

Referring now to FIG. 6, a block diagram shows components of a computer system that computes a context feedback loss for language-driven editing of image scenes with machine learning, in accordance with an embodiment of the present invention.

In an embodiment, the LDIE 300 can process source image/video 102 and user query 103 to determine the context feedback loss 325 for training. The LDIE 300 can utilize a VLM 301 to generate a source caption 601 that describes the context of the scene of the source image/video 102. The source caption 601, the user query 103, and the source image/video 102 can be processed by a large language model (LLM) 403 to generate a target caption 603 which describes the context of a target edited image based on the source caption 601 as the baseline caption, the user query 103, and the source image/video 102. The language-edited image 307 can be processed by the LLM 403 to generate an edited image caption 605 that describes the context of the language-edited image 307. The edited image caption 605 and the target caption 603 can be processed by the model trainer 320 to determine the context feedback loss 325.

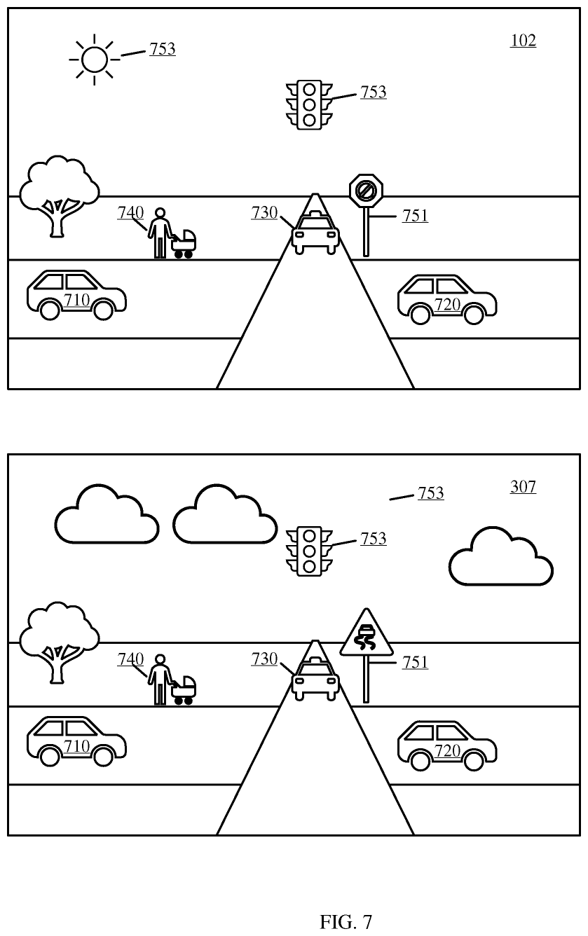

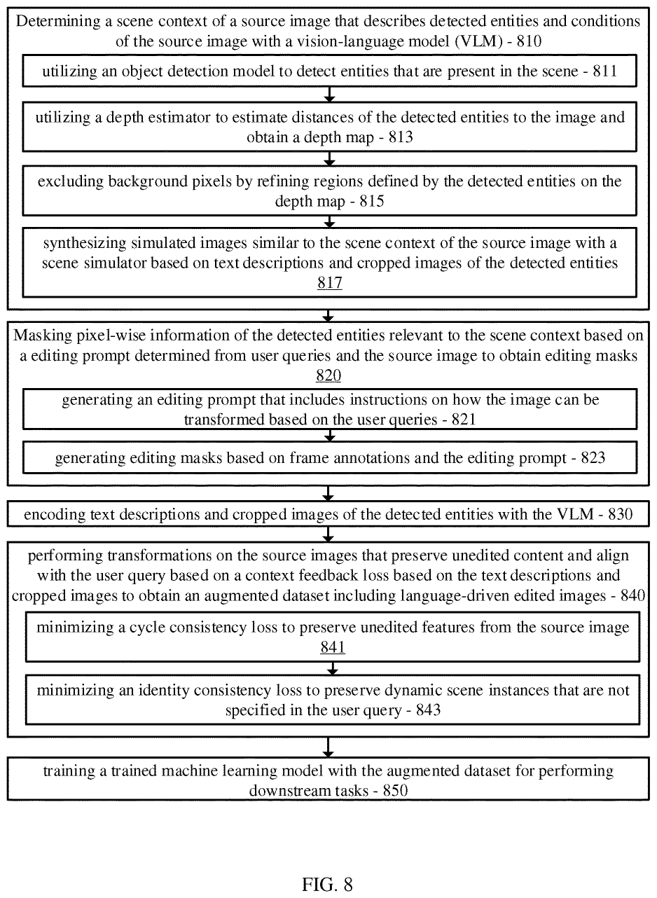

Referring now to FIG. 7, a block diagram shows image processing for language-driven editing of image scenes with machine learning, in accordance with an embodiment of the present invention.

In an embodiment, source image/video 102 of a traffic scene can be processed by the LDIE 300. The LDIE 300 can understand the context of the traffic scene which can include a first vehicle 710 moving in the same direction as a second vehicle 720 as the light for the first vehicle 710 is green. The context can include that a pedestrian 740 is walking with a stroller on the sidewalk. The context can include that a taxi 730 is stopped in a one-way intersection as shown by the sign 751 and the light for taxi 730 is red. The context can also include that the weather 753 for the traffic scene is sunny.

The user queries 103 can include text instructions to change the context of the image/video 102. The text instructions can include “Change the weather to cloudy and change the no-entry sign to a road slippery when wet sign.” The LDIE 300 can process the user queries 103 and generate the language-edited image 307 which shows the updated version of the source image/video 102 based on the user queries 103.

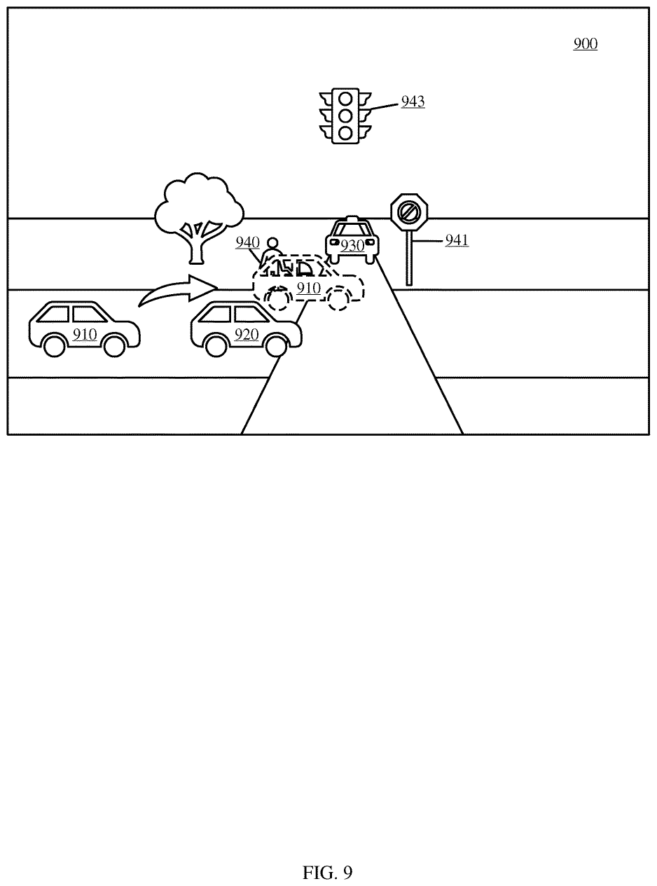

Referring now to FIG. 8, a flow diagram shows a high-level overview of language-driven editing of image scenes with machine learning, in accordance with an embodiment of the present invention.

In an embodiment, a scene context of a source image that describes detected entities and conditions of the source image can be determined with a vision-language model (VLM). Pixel-wise information of the detected entities relevant to the scene context can be masked based on an editing prompt determined from user queries and the source image to obtain editing masks. Text descriptions and cropped images of the detected entities can be encoded with the VLM. Transformations on the source images that preserve unedited content and align with the user query based on a context feedback loss based on the text descriptions and cropped images can be performed to obtain an augmented dataset including language-driven edited images. A trained machine learning model can be retrained with the augmented dataset for performing downstream tasks.

In block 810, a scene context of an image that describes entities and conditions of the scene can be determined with a vision-language model.

In an embodiment, to extract information about the surrounding environment, an image-based vision-language model (VLM) 301 can be utilized for a global interpretation of the scene. The source image/video 102 can be aligned by minimizing camera pose disparities, below a fixed tolerance by utilizing an equally weighted sum of angular orientation and Euclidean position.

$${I}_{target} = arg {min}_{I ∈ 𝒥} dist ( I , {I}_{s o u r c e} )$$

$$dist ( {I}_{a} , {I}_{b} ) = {‖ {\vec{x}}_{a} - {\vec{x}}_{b} ‖}_{2} + w * ( \vert {ϕ}_{a} - {ϕ}_{b} \vert + \vert {θ}_{a} - {θ}_{b} \vert + \vert {ψ}_{a} - {ψ}_{b} \vert )$$

where dist is the distance between two frames, [symbol] denotes the neighboring frames of I_{source}, a, b are the indices of two such frames, x is the camera's Euclidean position, w is the weight, and φ, θ, ψ are its roll, pitch, and yaw respectively.

In block 811, an object detector can be utilized by the VLM to detect entities that are present in the scene.

In an embodiment, an object detector 302, utilizing a 2D object detection model, can be utilized by the VLM 301 that returns, for each detected object, a bounding box, a class label (from the set ‘ambulance’, ‘bicycle’, ‘traffic light’, ‘traffic cone’, ‘person’, ‘car’, ‘motorcycle’, ‘bus’, ‘building’, ‘fire truck’), and a unique object ID.

In block 813, a depth estimator can be utilized to estimate distances of the detected entities to the image and obtain a depth map. In an embodiment, the depth estimator 304, utilizing a depth estimation model, produces a depth map whose values correspond to real-world distances.

In block 815, background pixels can be excluded by refining regions defined by the detected entities on the depth map. In an embodiment, for each object, the depth map of the detected images can be cropped based on bounding boxes of the detected entities to obtain an entity region and then refine the entity region with a context mask to exclude background pixels. The editing mask 303 can be obtained from a segmentation model. The object's distance is taken as the mean depth over masked areas of the source image/video 102 through the context mask.

In an embodiment, conditions of the scene including fine-grained details of the entities can be extracted from the image by using each entity bounding box and utilizing, the VLM. The fine-grained details can include entity attributes such as vehicle color or traffic-light state.

In block 817, simulated images similar to the scene context of the source image can be synthesized with a scene simulator based on text descriptions and cropped images of the detected entities.

In an embodiment, a scene simulator 308 can be leveraged to synthesize images and videos from the perspective of an autonomous vehicle across diverse environments including urban, suburban, outdoor, etc., similar to the source image/video 102. In an embodiment, the frames from the simulated images and the source image/video 102 can be paired and annotations can be extracted from the simulation metadata. The source image/video 102 can include the simulated images.

To ensure quality and diversity, a multi-stage filtering process can be applied including: removing frames where edited subjects are too small or absent, eliminating frames with high visual similarity based on structural similarity index measure (SSIM) thresholds and color histogram correlation, and discarding redundant frames captured when the ego vehicle was stationary.

For global modifications without object-specific edits (such as weather and time-of-day changes), all non-redundant frames that pass similarity thresholds based on SSIM and color histograms can be retained.

In block 820, pixel-wise information of the detected entities relevant to the scene context can be masked based on a determined editing prompt determined from user queries and the source image to obtain editing masks

In block 821, an editing prompt that includes instructions on how the image can be transformed based on the user queries can be generated. In an embodiment, the editing prompt can include structured editing instructions that transform the global conditions, such as weather, time of day, road conditions, etc., and entity-specific conditions, such as entity size, position, attributes, etc. of the source image/video 102 into the language-edited image 307.

In block 823, editing masks can be generated based on frame annotations and the editing prompt. In an embodiment, to capture nuanced scene transformations, each global instruction is paired with the editing masks 303 with instance-specific editing instructions.

In an embodiment, the editing mask 303 can include at least two masks: a removal mask that identifies entities to be eliminated from the source image/video 102 and an addition mask that highlights regions for new object placement on the source image/video 102 based on the user queries 103.

The editing mask 303 can be constructed by comparing corresponding frame annotations through at least three steps: distance-based filtering, truncation, and occlusion handling.

In distance-based filtering, objects beyond a predefined distance such as 50 meters from the ego vehicle, are filtered and excluded unless they occupy significant image area. In truncation, undersized two-dimensional bounding boxes near image boundaries can be detected for truncation. In occlusion handling, overlapping vehicle bounding boxes are preserved to maintain scene coherence.

In block 830, text descriptions and cropped images of the detected entities can be encoded by the VLM. In an embodiment, for each masked object, the text description and a cropped image of the detected entities can be encoded with the VLM 301. Each encoding can be assigned to the corresponding masked pixel. Entities are processed in descending order of distance such that features of detected entities which appear closer to the ego camera may overwrite existing object encoding at the same pixel.

In block 840, transformations based on the text descriptions and cropped images can be performed on the source image that preserves unedited content that aligns with text instructions from the user query to obtain an augmented dataset including language-driven edited images.

In an embodiment, controlled edits between the base and modified simulations can be performed each spanning a predetermined period such as 30 seconds. For example, the transformations can include a structured approach: changes to pedestrian appearance are applied consistently across all pedestrians within a scene, with clothing variations sampled from a catalog and described in metadata. Similarly, vehicle modifications can be applied uniformly to maintain coherence. Weather conditions and time of day are selected from pre-constructed profiles to maintain environmental realism. For environmental elements, randomized textures can be assigned to road surfaces and buildings, with each building receiving a distinct texture enhancing scene variability. Each simulation captures comprehensive data through six ego-mounted cameras providing 360-degree coverage. The sensor suite records RGB images, depth maps, semantic segmentation maps, and instance segmentation maps for each frame. Additionally, per-frame attributes for all entities visible to the ego vehicle can be tracked and documented for precise tracking of object properties and behaviors. The controlled edits are performed in light of training objectives that preserve content and instruction alignment in instruction-guided driving scene editing.

When paired source-target examples are available, supervised fine-tuning can be leveraged to explicitly guide the model toward faithful instruction following. Each training instance includes a source scene, two natural language instructions describing the transformations to and from the target scene, a mask of instances to remove from the source scene, a mask of instances to add to the source scene, and the resulting edited target.

By conditioning the model on instruction-derived pixel masks modifications to specified areas can be constrained which allows the model to localize edits. This ensures that unedited structures, such as road geometry and lane markings are unchanged while surrounding vehicles and global features are edited.

For content preservation, masked supervision penalizes deviations in unedited regions. For instruction alignment, the model associates natural language embeddings with spatial operations, learning fine-grained correspondence between language and visual transformations. While this approach provides precise control, its reliance on paired data limits its scalability to driving datasets where explicit ground truth edits are unavailable.

Given paired training samples (xₐ, x_{b}, tₐ, t_{b}, Mᵣ, Mₐ), the generator f_{θ} produces an edited image \hat{x}_{b}=f_{θ}{xₐ, t, Mᵣ, Mₐ). Here, xₐ and x_{b} are the source image 102 and target images, tₐ, and t_{b} are the instructions to produce a and b respectively from the user queries 103, Mᵣ and Mₐ are the removal and addition masks relative to xₐ, and x_{b}=f_{θ}(xₐ, t_{b}, Mᵣ, Mₐ) is the generator's output. For unsupervised training x_{b} is a random sample. φ(•) denotes the feature extraction function of a pretrained convolutional neural network such as the Visual Geometry Group (VGG) network.

In block 841, a cycle consistency loss can be minimized to preserve unedited features from the source image.

In an embodiment, cycle consistency loss 321 determines whether the transformations to the source image are reversible by checking whether unedited features remain unedited. Without additional constraints, generative editing models may alter portions of the scene in regions unrelated to the instruction. By requiring the unedited image to be recoverable after a forward-backward editing cycle, the model is penalized for unnecessary deviations from the input. This encourages content preservation by discouraging drift. The cycle consistency loss 321 can be computed as [symbol] _{cycle}=λ_{cycle}∥f_{θ}(f_{θ}(xₐ,t_{b}),tₐ)−xₐ∥₁+λ_{cycle-lpips}∥φ(f_{θ}(xₐ,t_{b}),tₐ)−φ(xₐ)∥₂, where λ_{cycle} is a L1 loss and λ_{cycle-lpips} is a Learned Perceptual Image Patch Similarity (LPIPS) loss.

In block 843, identity consistency loss can be minimized to preserve dynamic scene instances that are not specified in the user query.

In an embodiment, the identity consistency loss 323 enforces that when user queries 103 including editing instructions correspond to no change (e.g., blank masks or re-adding removed content), the model reproduces the input. This teaches the model to preserve dynamic scene instances that are not specified in the editing instruction. The identity consistency loss 323 can be computed as [symbol] _{id}=λ_{id}∥f_{θ}(xₐ,tₐ)−xₐ∥₁+λ_{id-lpips}∥φ(f_{θ}(xₐ,tₐ))−φ(xₐ)∥₂, where λ_{id} is a L1 loss and λ_{id-lpips} is a LPIPS loss.

By combining pixel-level L1 and perceptual LPIPS losses, structural fidelity can be enforced while allowing stylistic variation. However, construction-based supervision is insufficient on its own: the model may collapse to an identity mapping, avoiding all edits to minimize loss. To overcome this degeneracy, a context feedback loss alignment based on language-image similarity can be utilized.

To counteract degeneracy, a context feedback loss 325 can be minimized. The context feedback loss 325 measures the alignment between the generated output and the provided instruction using a pretrained vision-language model. The context feedback loss 325 can be computed where CLIP is the function of the pretrained vision-language model as:

[symbol]

_{clip}=λ_{clip}(1−sim_{cos}(CLIP_{I}(\hat{x}_{b}),CLIP_{T}(t_{b})))+λ_{clip}(sim_{cos}(CLIP_{I}(\hat{x}_{b}),CLIP_{T}(tₐ))),

where sim_{cos} is cosine similarity. The context feedback loss 325 encourages outputs to move toward the intended semantic edit, thereby reinforcing instruction alignment (e.g., first operand of the equation). The context feedback loss 325 includes a misalignment penalty, which discourages similarity to source image description to prevent the model from reproducing the input (e.g., second operand).

The augmented dataset 117 can be generated based on the language-edited images 307 generated by the LDIE 300 based on the cycle consistency loss 321, identity consistency loss 323 and context feedback loss 325.

In block 450, a trained machine learning model can be trained with the augmented dataset for performing downstream tasks. In an embodiment, a trained machine learning model 11 can be trained using the augmented dataset 117. To train the trained machine learning model, an adversarial training method can be employed which utilizes a generator G and a discriminator. The generator, G seeks to fool the discriminator D while the discriminator distinguishes real from generated edits.

Generator Objective.

$${ℒ}_{G}^{a d v} = - {λ}_{g a n} {𝔼}_{{x}_{a} , t} [ D ( {f}_{θ} ( {x}_{a} , t ) ) ] . ,$$

where [symbol] ₓ_{ₐ}_{,t} is the expected value for the source images for instructions t

Discriminator Objective, [symbol] _{D}=λ_{gan}( [symbol] ₓ_{_{b}}[max(0,1−D(x_{b}))]+ [symbol] _{f(x}_{ₐ}_{,t}_{_{b}}₎[max(0,1+D(f_{θ}(xₐ,t)))]), where λ_{gan} is a scalar hyperparameter that weighs a hinge generative adversarial neural network loss, [symbol] ₓ_{_{b}} is the expected value over real target images x_{b}, [symbol] _{f(x}_{ₐ}_{,t}_{_{b}}₎ is the expected value of the generator for source images for instructions t_{b}.

Collectively, these losses encode the two properties critical for safe and controllable scene editing: content preservation, achieved via cycle, identity, and masked supervision, and instruction alignment, realized through similarity and instruction-conditioned supervised constraints. By doing so, the present embodiments reduce the dependency of machine learning models on real-world data, which pose an issue due to rare occurrences, to generate transformed scenes based on user queries. As such, the present embodiments reduce the system complexity and computational resource costs for training machine learning models to process images based on user queries.

Referring now to FIG. 9, a block diagram shows a practical application of language-driven editing of image scenes with machine learning, in accordance with an embodiment of the present invention.

In an embodiment, in traffic scene 900, vehicle 910 can communicate with analytic server 109 through a network. User queries 103 can be communicated to vehicle 910 through an artificial intelligence (AI) agent that can communicate with the analytic server 106. The user queries 128 can include commands to control vehicle 910 such as controlling the components of the vehicle (e.g., air quality control, entertainment components such as radio, etc.) and controlling the trajectory of the vehicle (e.g., speeding up, braking, changing direction, etc.) through autonomous decision making.

Vehicle 910 can autonomously understand the traffic scene 900 and generate augmented dataset 117 based on the traffic scene. The augmented dataset 117 can include transformations to the traffic scene 900 obtained by the trained machine learning model 118 utilized by the vehicle 910. The augmented dataset 117 can be utilized by the model trainer 320 to train the trained machine learning model 118 and obtain retrained ML model 119. In another embodiment, the trained machine learning model 118 can be trained continuously with the augmented dataset 117 generated in real-time.

The retrained ML model 119 can generate predictions of trajectories of the entities in the traffic scene 900. For example, the trajectories can include the following: “it is safe to cross the intersection and overtake vehicle (920) that is in the intersection as pedestrian (940) is crossing parallel to the intersection and taxi (930) is stopped behind one-way sign (941) as the light on (943) is red for taxi (930) and green for vehicle (920).”

In another embodiment, in traffic scene 900, vehicle 910 can simulate trajectories for the identified entities. In another embodiment, in traffic scene 900, based on the simulated trajectories of the identified entities, vehicle 910 can generate a trajectory to avoid the simulated trajectories of the identified entities and avoid collisions. In another embodiment, the vehicle 910 can be autonomously controlled based on the generated trajectory to avoid collisions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well as any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
determining a scene context of a source image that describes detected entities and conditions of the source image with a vision-language model (VLM);
masking pixel-wise information of the detected entities relevant to the scene context based on an editing prompt determined from user queries and the source image to obtain editing masks;
encoding text descriptions and cropped images of the detected entities with the VLM;
performing transformations on the source images that preserve unedited content and align with the user query based on a context feedback loss based on the text descriptions and cropped images to obtain an augmented dataset including language-driven edited images; and
retraining a trained machine learning model with the augmented dataset to obtain a retrained machine learning model for performing downstream tasks.

2. The method of claim 1, wherein determining the scene context further includes utilizing an object detection model to detect entities that are present in the scene.

3. The method of claim 2, wherein determining the scene context further includes utilizing a depth estimator to estimate distances of the detected entities to the image and obtain a depth map.

4. The method of claim 3, wherein determining the scene context further includes excluding background pixels by refining regions defined by the detected entities on the depth map.

5. The method of claim 3, wherein determining the scene context further includes synthesizing simulated images similar to the scene context of the source image with a scene simulator based on text descriptions and cropped images of the detected entities.

6. The method of claim 1, wherein masking the pixel-wise information further includes generating an editing prompt that includes instructions on how the image can be transformed based on the user queries.

7. The method of claim 6, wherein masking the pixel-wise information further includes generating editing masks based on frame annotations and the editing prompt.

8. The method of claim 1, wherein performing the transformations further includes minimizing a cycle consistency loss to preserve unedited features from the source image.

9. The method of claim 1, wherein performing the transformations further includes minimizing an identity consistency loss to preserve dynamic scene instances that are not specified in the user query.

10. The method of claim 1, wherein the downstream tasks include generating trajectories to control an autonomous vehicle that utilizes the retrained machine learning model to traverse a traffic scene and avoid detected entities through autonomous decision making.

11. A system, comprising:
a memory device;
one or more processor devices operatively coupled with the memory device to perform operations including:
determining a scene context of a source image that describes detected entities and conditions of the source image with a vision-language model (VLM);
masking pixel-wise information of the detected entities relevant to the scene context based on an editing prompt determined from user queries and the source image to obtain editing masks;
encoding text descriptions and cropped images of the detected entities with the VLM;
performing transformations on the source images that preserve unedited content and align with the user query based on a context feedback loss based on the text descriptions and cropped images to obtain an augmented dataset including language-driven edited images; and
retraining a trained machine learning model with the augmented dataset to obtain a retrained machine learning model for performing downstream tasks.

12. The system of claim 11, wherein determining the scene context further includes utilizing an object detection model to detect entities that are present in the scene.

13. The system of claim 12, wherein determining the scene context further includes utilizing a depth estimator to estimate distances of the detected entities to the image and obtain a depth map and excluding background pixels by refining regions defined by the detected entities on the depth map.

14. The system of claim 13, wherein determining the scene context further includes synthesizing simulated images similar to the scene context of the source image with a scene simulator based on text descriptions and cropped images of the detected entities.

15. The system of claim 11, wherein masking the pixel-wise information further includes generating an editing prompt that includes instructions on how the image can be transformed based on the user queries.

16. The system of claim 11, wherein masking the pixel-wise information further includes generating editing masks based on frame annotations and the editing prompt.

17. The system of claim 11, wherein performing the transformations further includes minimizing a cycle consistency loss to preserve unedited features from the source image.

18. The system of claim 11, wherein performing the transformations further includes minimizing an identity consistency loss to preserve dynamic scene instances that are not specified in the user query.

19. The system of claim 11, wherein the downstream tasks include generating trajectories to control an autonomous vehicle that utilizes the retrained machine learning model to traverse a traffic scene and avoid detected entities through autonomous decision making.

20. A non-transitory computer program product comprising a computer-readable storage medium including a program code, wherein the program code when executed on a computer causes the computer to perform operations including:
determining a scene context of a source image that describes detected entities and conditions of the source image with a vision-language model (VLM);
masking pixel-wise information of the detected entities relevant to the scene context based on an editing prompt determined from user queries and the source image to obtain editing masks;
encoding text descriptions and cropped images of the detected entities with the VLM;
performing transformations on the source images that preserve unedited content and align with the user query based on a context feedback loss based on the text descriptions and cropped images to obtain an augmented dataset including language-driven edited images; and
retraining a trained machine learning model with the augmented dataset to obtain a retrained machine learning model for performing downstream tasks.
